(19) United States
(12) Patent Application Publication
(10) Pub. No.: US 2017/0145946 A1
(43) Pub. Date: May 25, 2017

(54) CONTROL DEVICE FOR INTERNAL COMBUSTION ENGINE

(71) Applicant: TOYOTA JIDOSHA KABUSHIKI KAISHA, Toyota-shi, Aichi-ken (JP)

(72) Inventor: Shingo KORENAGA, Shizuoka-shi (JP)

(73) Assignee: TOYOTA JIDOSHA KABUSHIKI KAISHA, Toyota-shi, Aichi-ken (JP)

(21) Appl. No.: 15/309,883

(22) PCT Filed: May 29, 2015
(86) PCT No.: PCT/JP2015/002739

§ 371 Date: Nov. 9, 2016

(30) Foreign Application Priority Data
May 30, 2014 (JP) 2014-113146

(51) Int. Cl. F02D 43/00; F02D 41/06; F02P 5/04; F02D 13/02

(52) U.S. Cl. CPC F02D 43/00; F02D 13/02; F02D 41/068; F02P 5/04

(57) ABSTRACT

A control device for an internal combustion engine is provided. The device has a catalyst unit and a controller that has been programmed so as to control the internal combustion engine. The controller is programmed so as to execute an A/F vibration operation that performs lean combustion in at least one cylinder and performs rich combustion in at least one another cylinder, an early closing operation that advances a valve closing timing of an exhaust valve to an earlier timing than an intake top dead center, and an ignition retard angle operation that retards an ignition timing. In a case where combustion is unstable, the controller advances the ignition timing and to enlarge an amplitude of an air-fuel ratio in the A/F vibration operation, in comparison with a case where the combustion is stable.

### TECHNICAL FIELD

The present invention relates to a control device for an internal combustion engine and, in particular, relates to a device having a function of controlling a fuel injection amount in order to accelerate warm-up of a catalyst.

### BACKGROUND ART

In regard to a case where the temperature of the catalyst does not reach an activation temperature at cold start of the internal combustion engine and so forth, various kinds of technologies for improving emission are proposed. One of such technologies is a method of controlling a timing that an intake valve and an exhaust valve are opening simultaneously, that is, a so-called valve overlapping amount. In this method, an emission gas which has been emitted to an exhaust passage is again sucked into a combustion chamber within a time of valve overlapping. Therefore, unburned components such as HC in the emission gas are burned in the combustion chamber and emission thereof is suppressed.

However, the amount of the emission gas that is sucked again into the combustion chamber in valve overlapping depends on a pressure difference between an intake passage and the exhaust passage. In a case where it does not yet reach an idle speed such as that at engine start-up, the pressure of the intake passage is not sufficiently lowered and therefore the pressure difference between the intake passage and the exhaust passage may become insufficient. In order to cope with this problem, in the device disclosed in Patent Literature 1, a closing timing of the exhaust valve is controlled to an earlier timing than the intake top dead center (that is, the advance angle side) at the engine start-up (hereinafter, referred to as an early closing operation). Thereby, a combustion gas can be confined in the combustion chamber and the unburned components in the combustion gas can be burned.

The device disclosed in Patent Literature 2 executes air-fuel ratio frequency control (an A/F vibration operation in the present specification) that alternately repeats increasing and decreasing of the fuel injection amount, and retarding of the ignition timing, aiming to early raise catalyst temperature and utilize it as a heat source for heating the inside of a car compartment. When oxygen supply by lean combustion and supply of combustible contents (CO (carbon monoxide) and so forth) by rich combustion are performed by the air-fuel ratio frequency control, oxidation reaction of CO in the catalyst and in the exhaust passage in the vicinity of an inlet of the catalyst is increased, the catalyst is heated with heat generated by this oxidation reaction, and warm-up of the catalyst is accelerated. Combustion is performed after a compression top dead center that is closer to an exhaust stroke by retarding of the ignition timing, a high-temperature emission gas is guided to the catalyst and warm-up of the catalyst is accelerated.

### CITATION LIST

### Patent Literature

PTL 1: Japanese Patent Laid-Open No. 2003-120348

PTL 2: Japanese Patent Laid-Open No. 2005-016477

### SUMMARY OF INVENTION

### Technical Problem

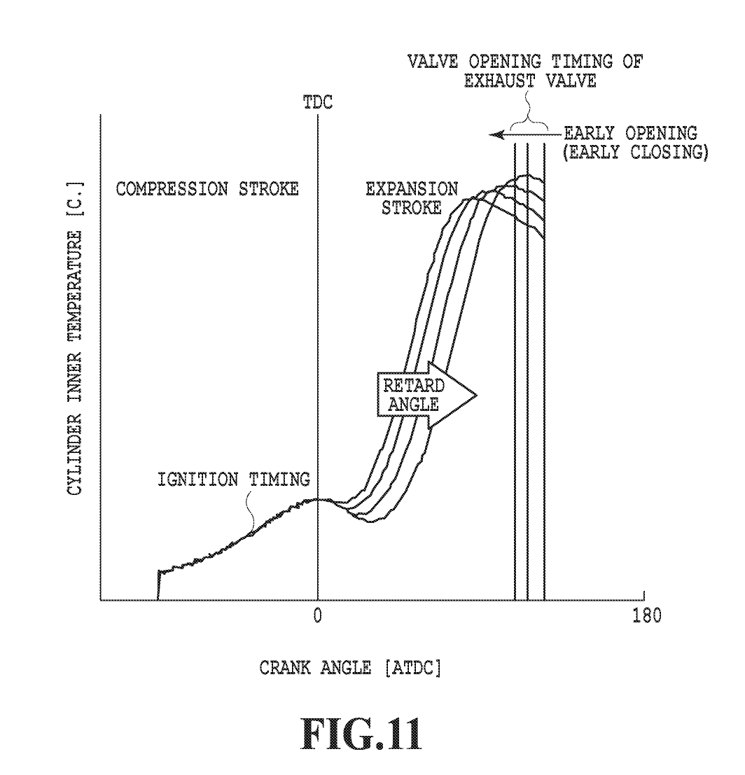

However, when the early closing operation of the exhaust valve such as that disclosed in Patent Literature 1 is performed, there is a tendency that an opening timing of the exhaust valve also advanced. Accordingly, when the early closing operation of the exhaust value and retarding of the ignition timing such as that in Patent Literature 2 are performed simultaneously, a time taken from ignition to opening of the exhaust valve is shortened (see FIG. 11). Therefore, heat by combustion in the combustion chamber is discharged through the exhaust valve before it is sufficiently converted into a rotary motion of the engine and torque is reduced. In addition, a rate of the gas that is sucked again into the combustion chamber is increased. Accordingly, it is feared that the combustion may become unstable and rotational fluctuation may become large, and drivability may be worsened. If the ignition timing is advanced in order to suppress such rotational fluctuation, warm-up of the catalyst will be suppressed. There are cases where variable lift amount control for suppressing advancement of an opening timing of the exhaust valve in association with the early closing operation, and control of retardation of a valve timing using feedback are difficult or insufficient because a lubricant oil viscosity is high at cold start.

The present invention has been made in order to solve the problems as mentioned above and aims to simultaneously attain suppression of the rotational fluctuation and acceleration of warm-up of the catalyst in a device configured to simultaneously perform early closing of the exhaust valve and retarding of the ignition timing.

### Solution to Problem

A first aspect of the present invention is

a control device for an internal combustion engine configured to control an internal combustion engine including a catalyst unit in an exhaust passage, the control device including:

A/F vibration unit for causing lean combustion to be performed in at least one cylinder and causing rich combustion to be performed in at least one another cylinder in a case where a warm-up request of the catalyst unit has been made;

early closing unit for advancing a valve closing timing of an exhaust valve to an earlier timing than an intake top dead center in a case where the warm-up request has been made; and

ignition retard angle unit for retarding an ignition timing in a case where the warm-up request has been made, wherein

The control device is further configured, in a case where combustion is unstable, to make small a retard angle amount of an ignition timing of the cylinder in which the lean combustion is performed, the retard angle amount of an ignition timing being provided by the ignition retard angle unit, and to make large an amplitude of an air-fuel ratio that is provided by the A/F vibration unit, in comparison with a case where the combustion is stable.

According to this aspect, in the case where combustion is unstable, a retard angle amount of the ignition timing of the cylinder in which the lean combustion is performed is made small, the retard angle amount of the ignition timing being provided by the ignition retard angle unit, and the amplitude of the air-fuel ratio that is provided by the A/F vibration unit is made large in comparison with a case where the combustion is stable. Accordingly, worsening of the drivability can be suppressed by accelerating stability of combustion by reducing the retard angle amount of the ignition timing and it is possible to compensate for lowering of the warm-up performance of the catalyst in association with ignition advance by enlargement of the amplitude of the air-fuel ratio.

According to another aspect of the present invention,

the control device is further configured, after termination of the A/F vibration operation, to correct the ignition timing of the cylinder in which the lean combustion has been performed by the A/F vibration unit, to an earlier timing than the ignition timing that has been used in the lean combustion, as a current air-fuel ratio is larger.

When the early closing operation by the above-mentioned early closing unit and the A/F vibration operation by the A/F vibration unit are executed simultaneously, combustibility directly after termination of the A/F vibration operation in the cylinder to which lean combustion has been allocated in the A/F vibration operation is worsened, because an amount (a so-called internal EGR amount) of the burned gas in the combustion chamber is large. In regard to this, according to the aspect of the present invention, after termination of the A/F vibration operation, the ignition timing of the cylinder in which the lean combustion has been performed in the A/F vibration operation is corrected, to an earlier timing than the ignition timing that has been used in the lean combustion, as the current air-fuel ratio is larger. Therefore, worsening combustion in the cylinder to which the lean combustion has been allocated can be suppressed.

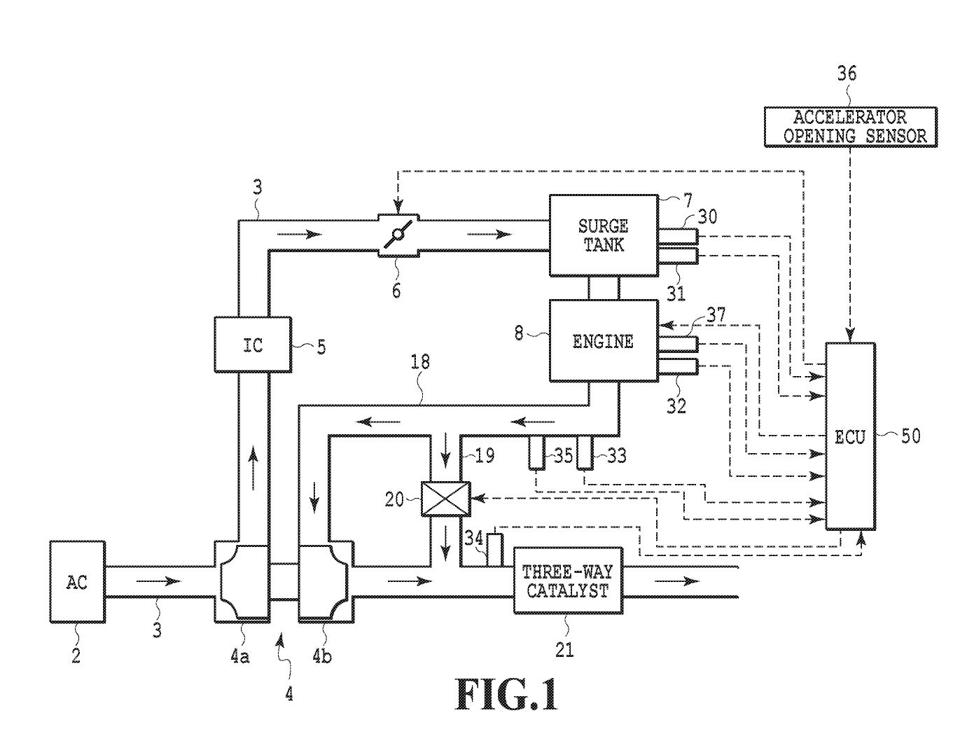

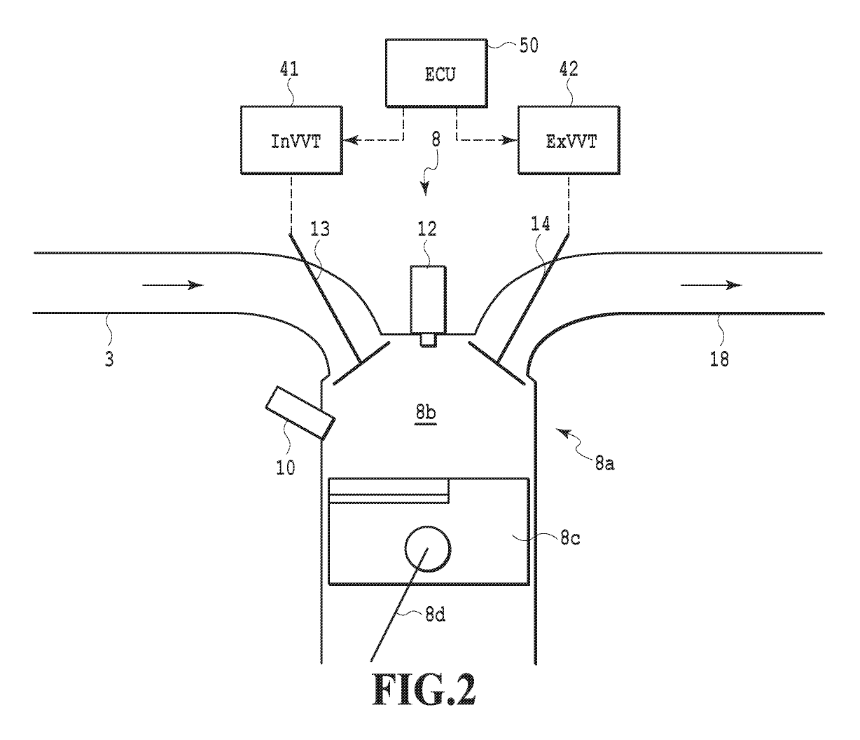

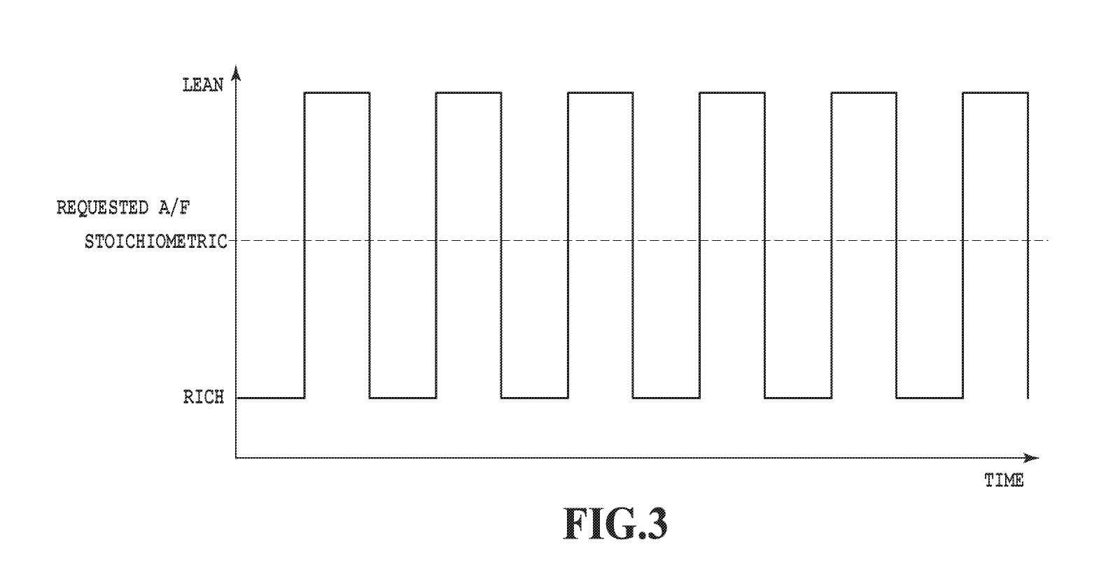

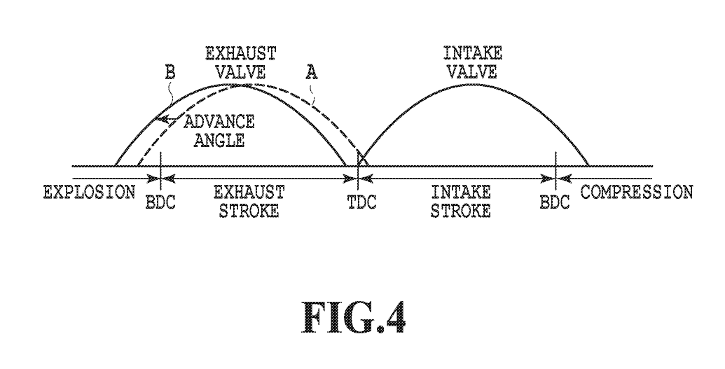

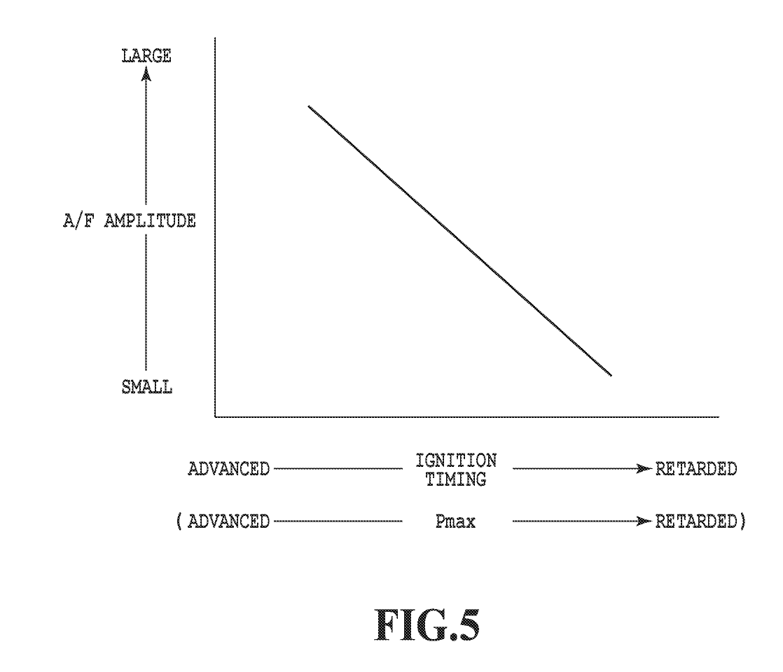

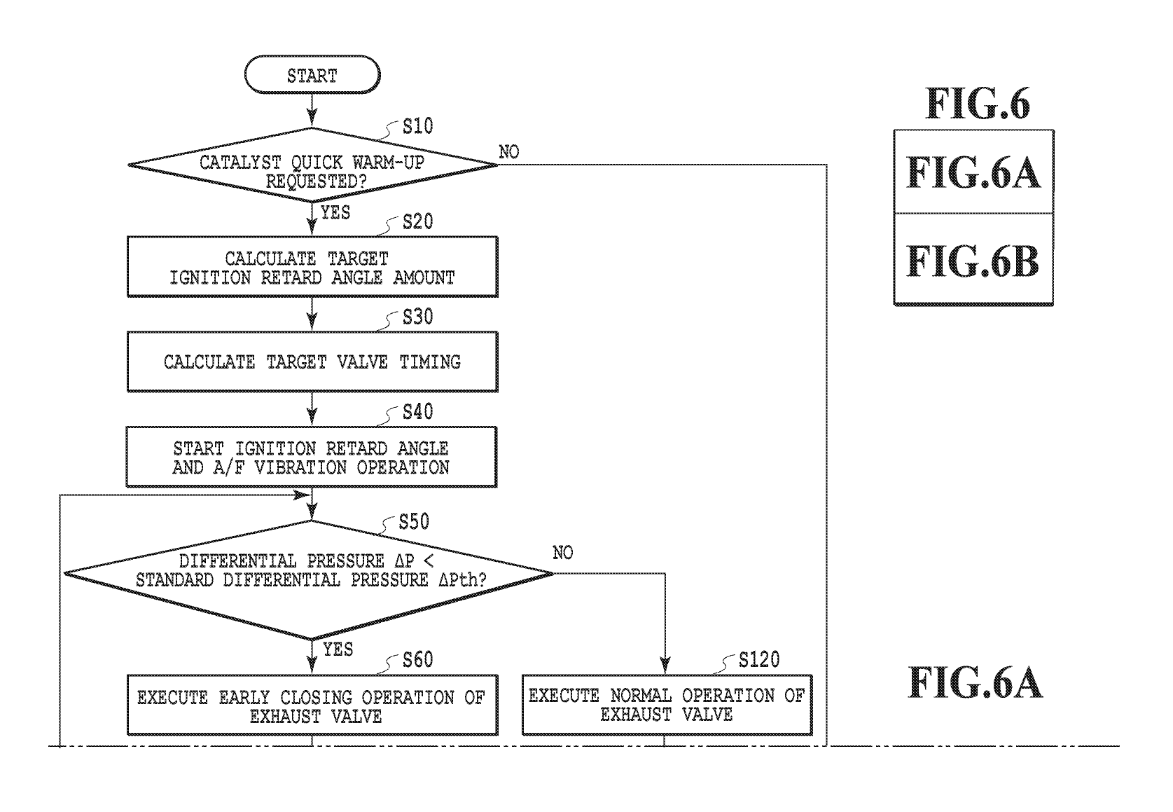

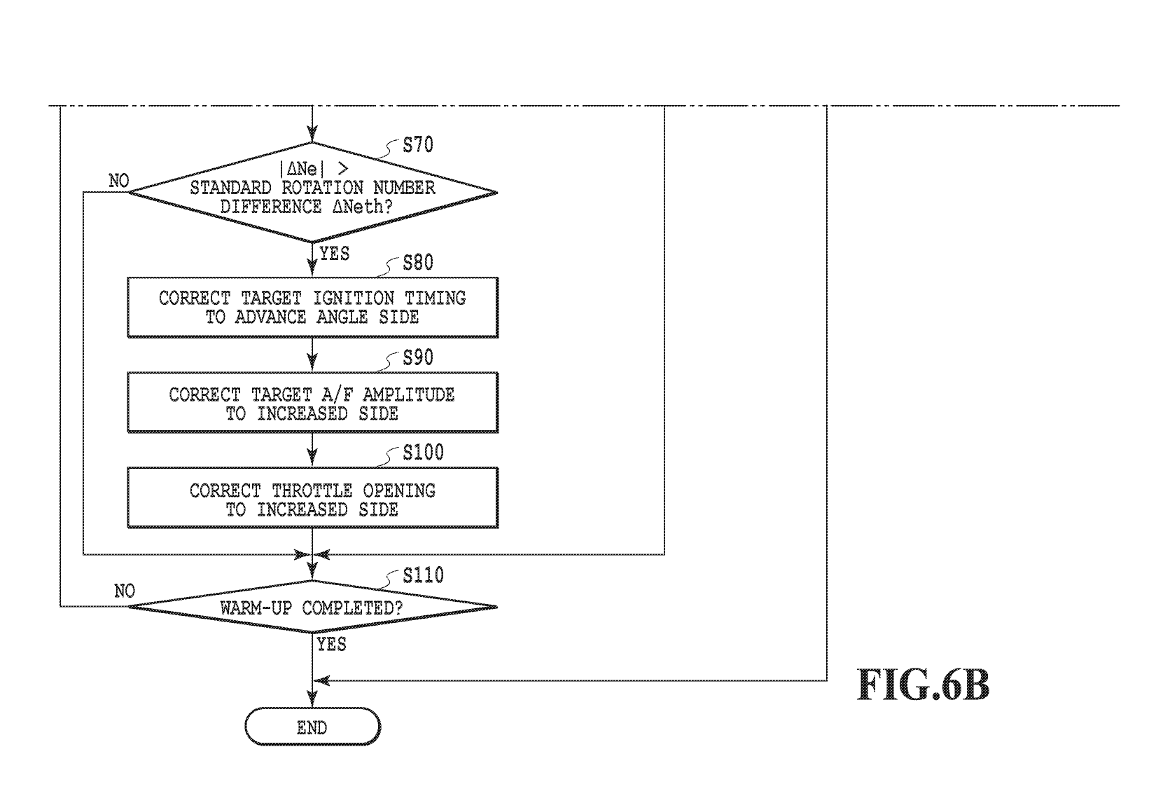

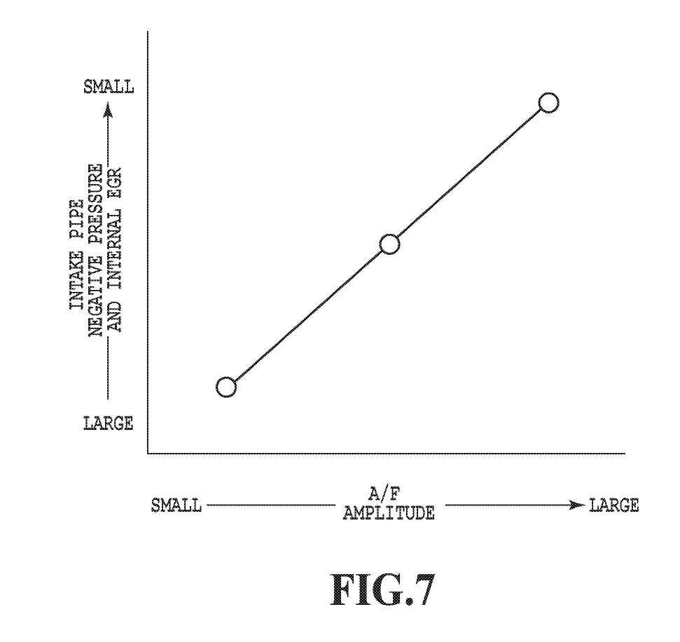

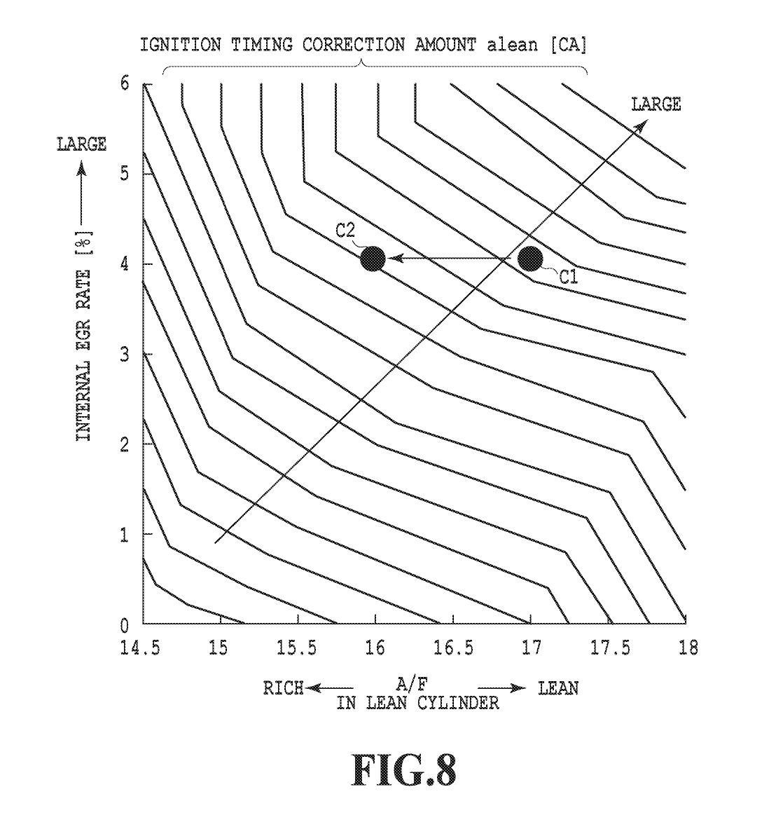

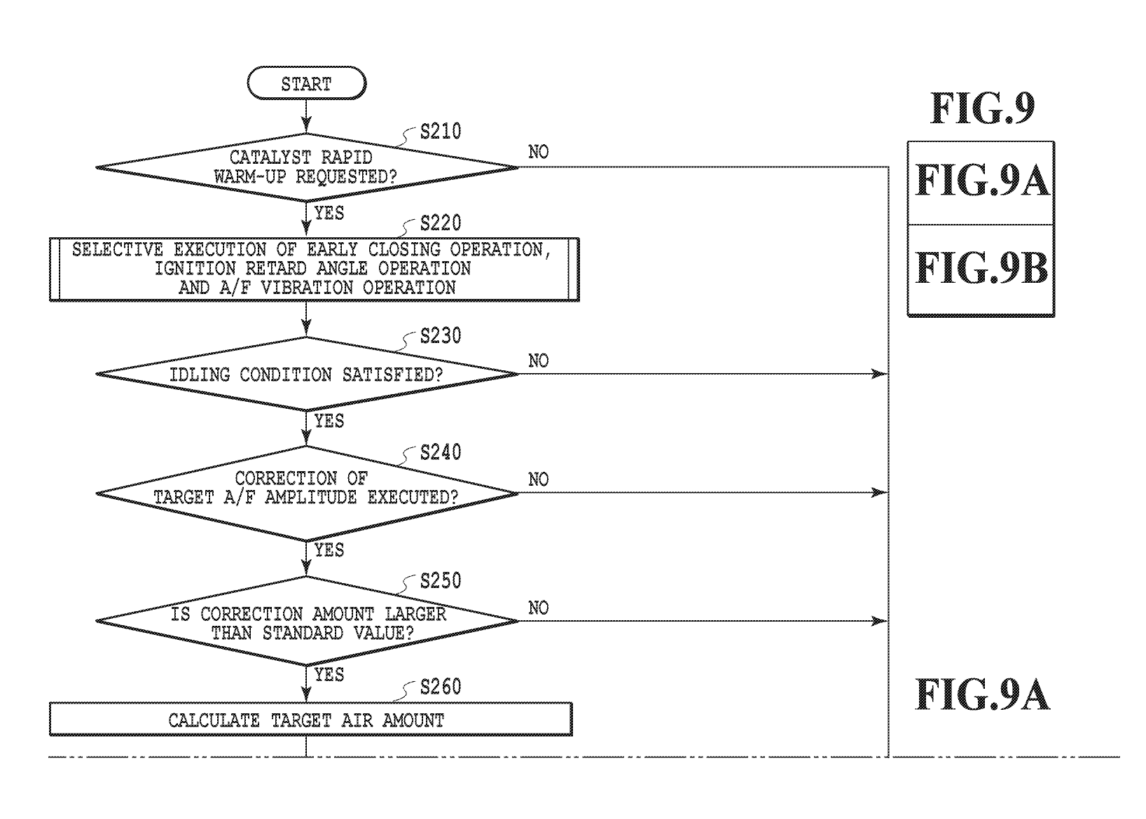

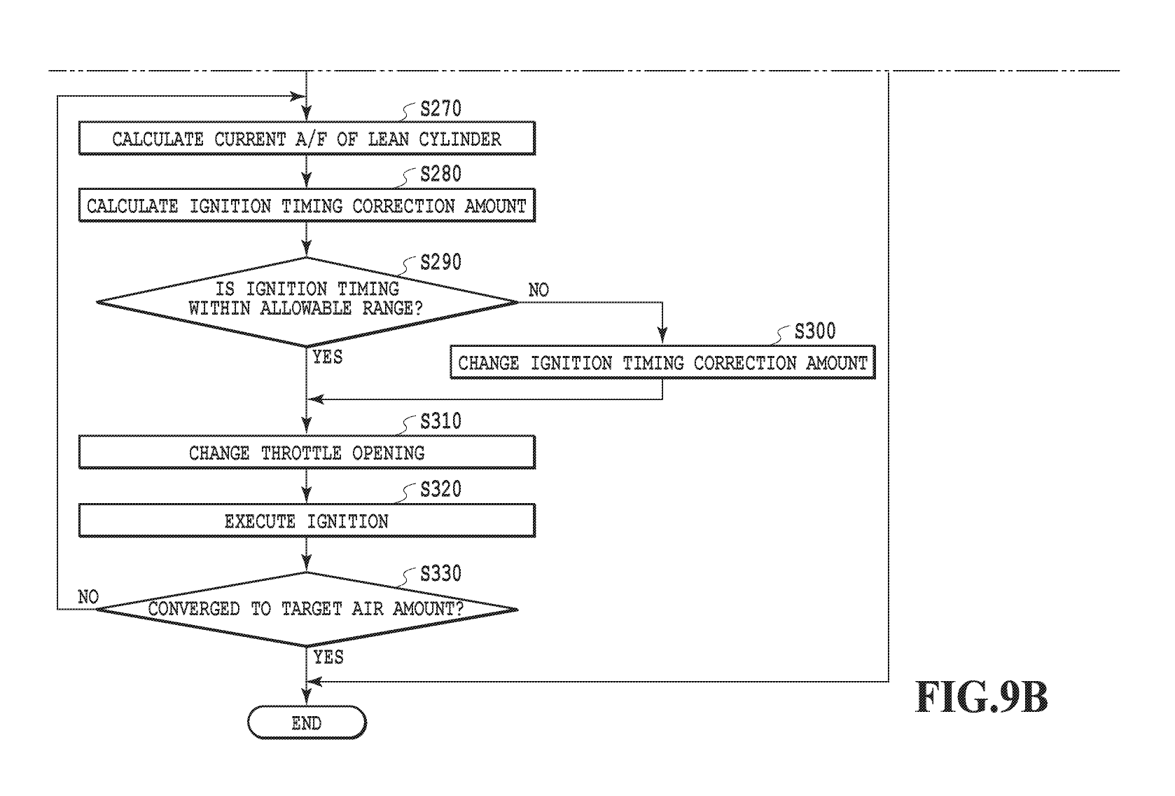

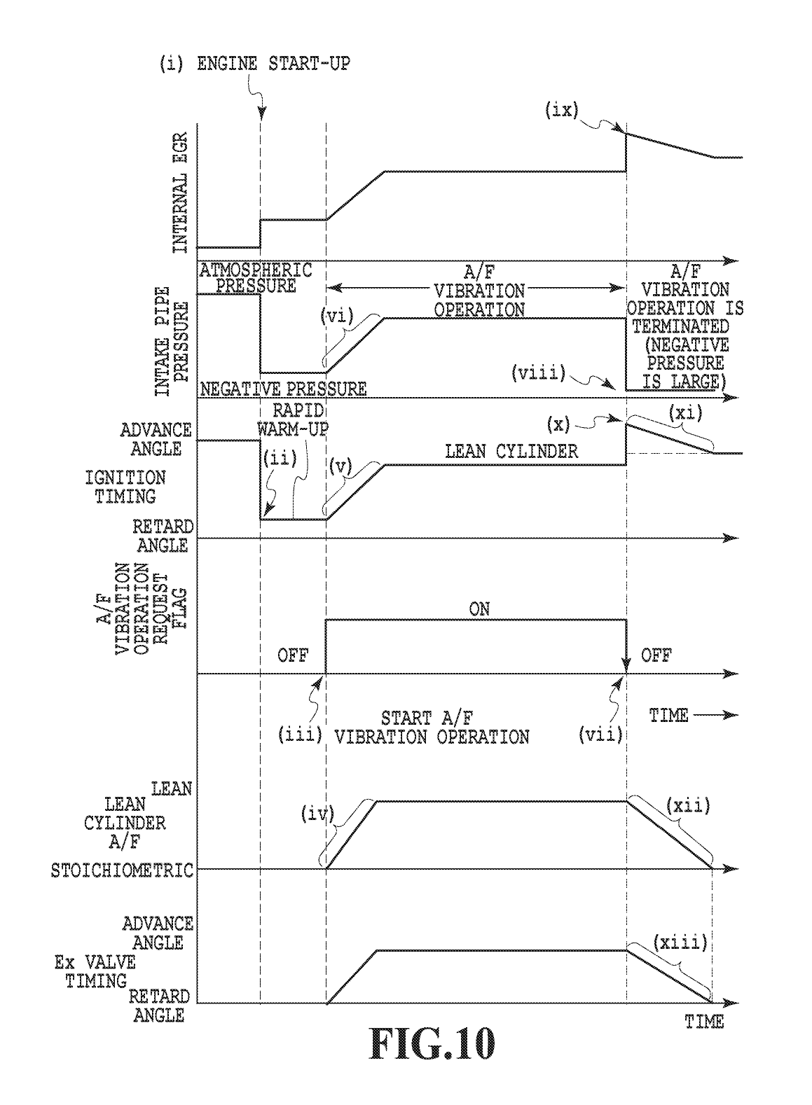

### BRIEF DESCRIPTION OF DRAWINGS

[FIG. 1] FIG. 1 is a conceptual diagram showing configuration of a vehicle to which a control device for an internal combustion engine according to an embodiment of the present invention has been applied;

[FIG. 2] FIG. 2 is a conceptual diagram showing a schematic configuration of an engine;

[FIG. 3] FIG. 3 is a timing chart showing one example of a change in requested A/F in execution of an A/F vibration operation;

[FIG. 4] FIG. 4 is a timing chart showing openings of an intake valve and an exhaust valve;

[FIG. 5] FIG. 5 is a graph showing a setting example of a map that defines a relation between an ignition timing and an A/F amplitude;

[FIG. 6] FIG. 6 is a diagram showing the relation between FIG. 6A and FIG. 6B;

[FIG. 6A] FIG. 6A is a flowchart showing a routine of a catalyst warm-up process in a first embodiment;

[FIG. 6B] FIG. 6B is a flowchart showing the routine of the catalyst warm-up process in the first embodiment;

[FIG. 7] FIG. 7 is a graph showing a relation between the A/F amplitude, and an intake pipe negative pressure and an internal EGR amount;

[FIG. 8] FIG. 8 is a graph showing a setting example of an ignition timing correction amount map used in a second embodiment;

[FIG. 9] FIG. 9 is a diagram showing the relation between FIG. 9A and FIG. 9B;

[FIG. 9A] FIG. 9A is a flowchart showing a routine of a catalyst warm-up process in the second embodiment;

[FIG. 9B] FIG. 9B is a flowchart showing the routine of the catalyst warm-up process in the second embodiment;

[FIG. 10] FIG. 10 is a timing chart showing one example of a change in each parameter in the second embodiment; and

[FIG. 11] FIG. 11 is a graph showing a relation between. a retard angle amount of the ignition timing and an in-cylinder temperature, and a relation between them and a valve-opening timing of an exhaust valve.

### DESCRIPTION OF EMBODIMENTS

### First Embodiment

In the following, preferred embodiments of the present invention will be described with reference to the drawings.

### [General Configuration]

FIG. 1 is a schematic diagram showing a configuration of a vehicle to which a control device for an internal combustion engine according to the present embodiment has been applied. Incidentally, in FIG. 1, solid-line arrows indicate flows of a gas and broken-line arrows indicate input/output of signals.

In FIG. 1, the vehicle possesses an air cleaner (AC) 2, an intake passage 3, a turbo supercharger 4, an inter-cooler (IC) 5, a throttle valve 6, a surge tank 7, an engine (an internal combustion engine) 8, an exhaust passage 18, a bypass passage 19, a wastegate valve 20, a three-way catalyst 21, an air flow meter 30, an intake temperature sensor 31, a water temperature sensor 32, an oxygen sensor 33, an A/F sensor 34, an exhaust pressure sensor 35, an accelerator opening sensor 36, a crank angle sensor 37, and an ECU (Electronic Control Unit) 50. The engine 8 is an in-line 4-cylinder reciprocating type gasoline engine.

The air cleaner 2 filters air (intake air) acquired from the outside and supplies it to the intake passage 3. In the intake passage 3, a compressor 4a of the turbo supercharger 4 is disposed and the intake air is compressed (supercharged) by rotation of the compressor 4a. In the intake passage 3, the inter-cooler 5 for cooling the intake air and the throttle valve 6 for adjusting an amount of the intake air to be supplied to the engine 8 are further provided.

The intake air that has passed through the throttle valve 6 is temporarily stored in the surge tank 7 formed on the intake passage 3 and thereafter flows into a plurality of cylinders (not shown) that the engine 8 has. The engine 8 generates power by burning a gaseous mixture that the supplied intake air has been mixed with fuel in the cylinders. An emission gas that has been generated by combustion in the engine 8 is emitted to the exhaust passage 18. Various kinds of control of the engine 8 are performed with control signals supplied from the ECU 50, and such various kinds of control include control of the ignition timing, control of a fuel injection amount and control of an injection timing of the fuel.

Here, a specific configuration of the engine 8 will be described with reference to FIG. 2. The engine 8 mainly has a cylinders 8a, fuel injection valves 10, ignition plugs 12, intake valves 13, and exhaust valves 14. Incidentally, although in FIG. 2, only one cylinder 8a is shown for the convenience of description, the engine 8 actually has a plurality of cylinders 8a.

The fuel injection valve 10 is provided in the cylinder 8a and directly injects (cylinder injection) the fuel into a combustion chamber 8b of the cylinder 8a. The fuel injection valve 10 is controlled with the control signal supplied from the ECU 50. That is, the control of the fuel injection amount and so forth are executed by the ECU 50. Incidentally, it is not limited to configure the engine 8 with the fuel injection valve 10 that performs cylinder injection (direct injection) and the engine 8 maybe configured with a fuel injection valve that performs port injection.

The intake air is supplied from the intake passage 3 to the combustion chamber 8b of the cylinder 8a and the fuel is supplied from the fuel injection valve 10. In the combustion chamber 8b, the gaseous mixture of the supplied intake air with the fuel is burned by being fired by ignition of the ignition plug 12. In this case, a piston 8c reciprocally moves by combustion and this reciprocal movement is transmitted to a crank shaft (not shown) via a connecting rod 8d and the crank shaft rotates. The ignition plug 12 is controlled with the control signal supplied from the ECU 50. That is, the control of the ignition timing is executed by the ECU 50.

Further, the intake valve 13 and the exhaust valve 14 are disposed on the cylinder 8a. The intake valve 13 opens and closes and thereby controls conduction/shut-off between the intake passage 3 and the combustion chamber 8b. In addition, the exhaust valve 14 opens and closes and thereby controls conduction/shut-off between the exhaust passage 18 and the combustion chamber 8b.

Variable valve timing mechanisms (VVTs) 41 and 42 are provided in order to open and close the intake valve 13 and the exhaust valve 14 at predetermined timings. Each of the intake-side and exhaust-side VVTs 41 and 42 adjusts relative rotation phases between a cam shaft and the crank shaft and thereby can adjust valve opening and valve closing timings of the intake valve 13 and the exhaust valve 14. The VVTs 41 and 42 may be the ones that can further adjust lift amounts of the intake valve 13 and the exhaust valve 14. For the VVTs 41 and 42, the hydro-mechanical type ones that can discretely or continuously adjust the rotation phases and/or the lift amounts can be used. For the VVTs 41 and 42, also the ones of various well-known type such as, for example, a solenoid type valve mechanism may be used.

Returning to FIG. 1, other constitutional elements that the vehicle has will be described. The emission gas that has been emitted from the engine 8 rotates a turbine 4b of the turbo supercharger 4 that has been provided on the exhaust passage 18. The rotating torque of such a turbine 4b is transmitted to and rotates the compressor 4a in the supercharger 4 and thereby the intake air that passes through the turbo supercharger 4 is compressed (supercharged).

The bypass passage 19 that bypasses the upstream side and the downstream side of the turbo supercharger 4 is connected to the exhaust passage 18. The wastegate valve 20 is provided on this bypass passage 19. The wastegate valve 20 can take an optional opening such as full-closing, full-opening and an intermediate opening between them. Control of opening/closing of the wastegate valve 20 is performed by the ECU 50.

The three-way catalyst 21 having a function of purifying the emission gas is provided on the exhaust passage 18. Specifically, the three-way catalyst 21 is a catalyst that noble metals such as platinum and rhodium are used as active components and has a function of removing nitrogen oxides (NO), carbon monoxide (Ca), hydrocarbons (HC) and so forth in the emission gas. In addition, emission gas purification ability of the three-way catalyst 21 is changed depending on the temperature thereof. Describing in details, when the three-way catalyst 21 is set at a temperature in the vicinity of an activation temperature, the emission gas purification ability is heightened. Therefore, at the cold start and so forth, it is necessary to raise the temperature of the three-way catalyst 21 up to the activation temperature. Incidentally, the type of the catalyst is not limited to the three-way catalyst 21, various types of catalysts can be utilized and, in particular, the one that requires warm-up is favorable.

The air flow meter 30 is provided on the surge tank 7 and detects an intake air amount KL. The intake temperature sensor 31 is provided on the surge tank 7 and detects an intake temperature. This intake temperature corresponds to an outside air temperature. The water temperature sensor 32 detects a temperature of cooling water (hereinafter, referred to as an engine water temperature) for cooling the engine 8. The oxygen sensor 33 is provided on the exhaust passage 18 and detects a concentration of oxygen in the emission gas. The oxygen sensor 33 has such a characteristic that an output value is abruptly changed on the boundary of stoichiometry. The A/IF sensor 34 outputs a voltage signal of the magnitude that is almost proportional to a detected exhaust air-fuel ratio. The exhaust pressure sensor 35 detects a pressure on the upstream side (that is, on the upstream side of the turbine 4b) of the supercharger 4 on the exhaust passage 18. The detected pressure is used for estimating a temperature T on the upstream side of the supercharger 4. The accelerator opening sensor 36 detects an accelerator opening by a driver. The crank angle sensor 37 is provided in the vicinity of the crank shaft of the engine 8 and detects a crank angle. Detected values that these various kinds of sensors have detected are supplied to the ECU 50 as detection signals.

The ECU 50 is configured by including a CPU, a ROM, a RAM, a D/A converter and an A/D converter and so forth that are not shown. The ECU 50 performs control in the vehicle on the basis of outputs supplied from the various kinds of sensors in the vehicle. In the present embodiment, the ECU 50 mainly executes control for the wastegate valve 20, control for the ignition plug 12, control for the fuel injection valve 10, and control of the opening and closing timings of the intake and exhaust valves 13 and 14 by the VVTs 41 and 42. Specifically, in a case where a predetermined warm-up execution condition has been satisfied, the ECU 50 first brings the wastegate valve 20 to an opened state and executes retarding of the ignition timing, and executes an operation (hereinafter, referred to as an A/F vibration operation) by an aspect that vibrates the air-fuel ratio such that the lean combustion and the rich combustion are alternately switched. The purpose of performing the A/F vibration operation like this is to early warm-up the catalyst while appropriately suppressing slipping of CO, NC and so forth out of the catalyst. In addition, the ECU 50 executes the early closing operation of controlling the closing timing of the exhaust valve 14 to an earlier timing than the intake top dead center.

### [A/F Vibration Operation]

Next, the A/F vibration operation that the above-mentioned ECU 50 executes will be described. The A/F vibration operation in the present embodiment is executed for the purpose of performing early warm-up of the three-way catalyst 21 at the cold start and so forth.

Here, a basic A/F vibration operation will be described with reference to FIG. 3 FIG. 3 shows a change in a target air-fuel ratio when the A/F vibration operation has been executed.

As shown in FIG. 3, in the A/F vibration operation, control of vibrating the air-fuel ratio such that the lean combustion and the rich combustion are alternately switched per cylinder 8a and in ignition order is performed. Vibration of the air-fuel ratio is performed by increasing/decreasing the fuel injection amount. In the cylinder (the lean cylinder) that the air-fuel ratio is made lean and the cylinder (the rich cylinder) that it is made rich, the air-fuel ratios (A/F) are set to almost symmetric values with a stoichiometric value (for example, an optional value between 14.5 and 15 in weight ratio) being interposed. However, the operation may be performed such that the air-fuel ratios vibrate with a base air-fuel ratio other than the stoichiometric value being interposed.

In a case where the A/F vibration operation like this has been executed, a lean gas (O2 (oxygen) and so forth) is supplied to the exhaust passage 18 when the lean combustion is performed and a rich gas (CO (carbon monoxide) and so forth) is supplied thereto when the rich combustion is performed. Thereby, reaction (oxidation reaction) between CO and O2 in the exhaust passage 18 can be increased and it becomes possible to heat the three-way catalyst 21 with heat generated by this oxidation reaction and to accelerate warm-up of the catalyst.

In the present embodiment, since the engine 8 is 4-cylinder type, that is, an even number, the lean cylinders and the rich cylinders are fixed. In a case where the ignition order is “#1-#3-#4-#2” in cylinder number, the air-fuel ratio or a combustion aspect can be allocated such that, for example, “the #1 cylinder is made rich, the #3 cylinder is made lean, the #4 cylinder is made rich and the #2 cylinder is made lean”. However, in a case where the present embodiment is applied to an odd-number-cylinder type engine, the lean cylinders and the rich cylinders may be switched per cycle. In case of a V-type engine, allocation of the lean cylinders and the rich cylinders in accordance with the ignition order may be performed independently per bank and may be performed in accordance with the ignition order in both banks. In addition, in place of a configuration in which the lean combustion and the rich combustion are switched per cylinder 8a in the ignition order, a configuration in which they are switched in units of a plurality of cylinders or at intervals of a predetermined time may be used. In a case where the air-fuel ratios are switched in units of a plurality of cylinders or at the intervals of the predetermined time, the waveform of the air-fuel ratio may be a shape approximate to that of a sine wave or other shapes, not limited to a pulsed shape and an optional waveform can be selected such that the reaction is performed favorably.

### [Early Closing Operation of the Exhaust Valve]

Next, the early closing operation of the exhaust valve 14 that the above-mentioned ECU 50 executes will be described. In the present embodiment, the ECU 50 executes the early closing operation of the exhaust valve 14 at the cold start and so forth. “Early closing” of the exhaust valve 14 in the present specification means to set the closing timing of the exhaust valve 14 to an earlier timing than the intake top dead center. The combustion gas can be confined in the combustion chamber and the unburned components in the combustion gas can be burned by this early closing operation of the exhaust valve 14. In addition, since the closing timing of the exhaust valve 14 is set to an earlier timing than the intake top dead center, the burned gas blows out through the next opened intake valve 13 back into an intake port caused by compression in the combustion chamber 8b after valve closing of the exhaust valve 14, the liquid-phase fuel that has adhered in the intake port and the combustion chamber is microparticulated and is retained in the intake port and combustion thereof is accelerated. Accordingly, particulate matters (PM) in emission can be reduced.

The ECU 50 sets a target valve closing timing of the exhaust valve 14 on the basis of one or more of a cooling water temperature, an. intake temperature, a combustion chamber inner wall temperature, a combustion count after start-up, an elapsed time after start-up, an in-cylinder pressure, the ignition timing, an intake air amount, and the engine speed Me. Such setting can be stored into the ROM in the ECU 50 as a map or a function. As shown in FIG. 4, although the target valve closing timing is set to be a later timing than the intake top dead center TDC like a broken line A in a normal operation that the early closing operation is not performed, it is set to an earlier timing than the intake top dead center TDC like a solid line B when the early closing operation is performed. The opening and closing timings of the exhaust valve 14 are changed to the advance angle side by the exhaust-side VVT mechanism 42 in response to such setting of the target valve closing timing. Although in the present embodiment, an advance angle amount of the closing timing of the exhaust valve 14 in the early closing operation is set as a variable value, it may be a fixed value.

### [Advancement of Ignition Timing and A/F Amplitude]

In the present embodiment, in a case where the catalyst warm-up request has been made, the ECU 50 executes the A/F vibration operation, the early closing operation of the exhaust valve 14, and the ignition retard angle operation. However, even in the case where the catalyst warm-up request has been made, if combustion in the combustion chamber 8b is unstable, the ignition timing is advanced, and the amplitude of the air-fuel ratio in the A/F vibration operation is enlarged in comparison with a case where combustion is stable. As a result of such processing, it is possible to compensate for lowering of warm-up performance of the catalyst in association with ignition advance by enlargement of the amplitude of the air-fuel ratio, while accelerating stability of combustion by advancement of the ignition timing and suppressing worsening of the drivability. As shown in FIG. 5, it is favorable to set the A/F amplitude larger as the ignition timing is earlier, so as to compensate for lowering of the warm-up performance of the catalyst due to advancement of the ignition timing. Such setting can be stored into the ROM in the ECU 50 as the map or the function.

### [Catalyst Warm-up Process]

FIG. 6A and FIG. 6B are flowcharts showing a routine of a catalyst warm-up process in the present embodiment. This process is executed by the ECU 50 on condition that a decision of start-up of the engine 8 based on operation input of a not shown ignition switch and input of the crank angle sensor 37 has been made, and includes the above-mentioned A/F vibration operation.

First, in step S10, the ECU 50 decides whether or not the catalyst rapid warm-up request is present. The decision is made on the basis of, for example, whether the engine water temperature is lower than a predetermined standard value, and in a case where it is lower, it is decided that the rapid warm-up request is present. Incidentally, the decision can be made on the basis of one or more of the engine water temperature, an engine oil temperature and a catalyst temperature (any of them is a detected value or an estimated value). In a case where the rapid warm-up request is not present (step S10: No), the process leaves the routine.

In a case where the rapid warm-up request is present (step S10: Yes), the process proceeds to step S20. In step S20, the ECU 50 calculates the target ignition retard angle amount. The target ignition retard angle amount is set on the basis of, for example, the engine water temperature detected by the water temperature sensor 32 and with reference to a predetermined map. The lower the engine water temperature is, the larger the target ignition retard angle amount is set. The outside air temperature that is estimated with a detected value of the intake temperature sensor 31 may be used 3 place of the engine water temperature. In a case where the ignition timing of the ignition plug 12 is retarded up to after a compression top dead center, combustion is performed after the compression top dead center that is closer to the exhaust stroke and therefore the high-temperature emission gas is guided to the catalyst and activation of the catalyst is accelerated.

Next, in step S30, the ECU 50 calculates a target valve timing. As described above, the ECU 50 sets the target valve closing timing of the exhaust valve 14. For example, the ECU 50 calculates a requested load on the engine 8 from an intake air amount and an engine speed Ne and sets the target valve closing timing of the exhaust valve 14 on the basis of the requested load. As shown in FIG. 4, the target valve closing timing is set to a later timing than the intake top dead center TDC like the broken line A in the normal operation that does not perform the early closing operation, and is set to an earlier timing than the intake top dead center TDC like the solid line B when the early closing operation is performed. The smaller the pressure difference between the intake passage 3 and the exhaust passage 18 is, the larger the advance angle amount of the target valve closing timing may be set, so as to accelerate blowing of the burned gas back into the intake port when the intake valve 13 has opened.

Next, the ECU 50 starts retarding of the ignition timing and execution of the A/F vibration operation (step S40). As described above, in the A/F vibration operation, the lean combustion and the rich combustion are alternately performed. The ignition timing may have a fixed target value from the start of retarding, or may be gradually retarded from zero that is an initial value toward, for example, the fixed target value directly after the start of retarding. The air-fuel ratio amplitude may have the fixed target value from the starting time of the A/F vibration operation, or may be gradually enlarged from zero that is the initial value toward, for example, the fixed target value directly after the start of the A/F vibration operation.

Next, in step S50, the ECU 50 decides whether differential pressure ΔP between the intake passage and the exhaust passage is smaller than a predetermined standard differential pressure ΔPth. First, the ECU 50 calculates a pressure P1 of the intake passage 3 on the basis of the engine speed Ne calculated from the detected value of the crank angle sensor 37 and the intake air amount EL calculated from the detected value of the air flow meter 30, and reads in an exhaust pressure P2 that is the detected value of the exhaust pressure sensor 35. Then, it determines whether a differential pressure P2-P1 between these pressures P1 and P2 is smaller than the standard differential pressure ΔPth.

If NO in step S50, that is, if the differential pressure ΔP is not smaller than the standard differential pressure ΔPth, the process shifts to step S120 and executes the normal operation of the exhaust value 14. This normal operation is an operation aspect that does not perform early closing of the exhaust valve 14, and the emission gas that has been emitted to the exhaust passage is sucked again into the combustion chamber 8b, within a time of valve overlapping between the intake valve 13 and the exhaust valve 14 there. Therefore, the unburned components such as HC in the emission gas are burned in the combustion chamber 8b.

If YES in step S50, that is, if the differential pressure AP is smaller than the standard differential pressure ΔPth, the process shifts to step S60 and executes the early closing operation of the exhaust valve 14. In this early closing operation, the closing timing of the exhaust valve 14 is set to an earlier timing than the intake top dead center as described above. The combustion gas is confined in the combustion chamber 8b by this early closing operation of the exhaust valve 14, and blowing of the burned gas back into the intake port is accelerated and combustion of the unburned components in the combustion gas is accelerated.

Next, the process shifts to step S70, and the ECU 50 determines whether combustion in the engine 8 is unstable. This determination can be made on the basis of, for example, the engine speed Ne that is the detected value of the crank angle sensor 37. In this case, decision is made by calculating deviation ΔNe between the detected engine speed Ne and a detected value in a directly preceding control cycle thereof and comparing an absolute value |ΔNe| of the deviation ΔNe with a predetermined standard speed difference ΔNeth that is a positive value. If YES in step S60, that is, if the absolute value |ΔNe| of the deviation ΔNe is larger than the standard speed difference ΔNeth, the process proceeds to step S80.

In step S80, the ECU 50 corrects the target ignition timing of the ignition plug 12 to the advance angle side by predetermined unit angle. Consequently, the retard angle amount of the ignition timing in the ignition retard angle operation is changed to a smaller value. Next, in step S90, the ECU 50 enlarges the A/F amplitude. Enlargement of this A/F amplitude can be performed in accordance with the map or the function shown in the above-mentioned FIG. 5. As a result of processes in steps S80 and S90, the A/F amplitude is increased as the ignition timing is earlier, so as to compensate for lowering of the warm-up performance of the catalyst due to advancement of the ignition timing.

On the other hand, when the A/F amplitude is increased in this way, specific heat of the gaseous mixture in the combustion chamber is increased due to an increase in air amount particularly in the lean cylinder. As a result, there is a tendency that combustion becomes slow and the torque is reduced. Therefore, in parallel with control of the A/F amplitude, throttle opening correction to be done separately from this is performed (S100). With the throttle opening correction, the throttle opening is increased as the A/F amplitude is larger, so as to cancel out the reduction in torque due to the increase in A/F amplitude. The throttle opening correction like this is performed by utilizing the predetermined map or function stored in the ROM of the ECU 50.

Finally, the ECU 50 determines whether catalyst warm-up has been completed (S110). This determination can be made on the basis of at least one of, for example, an integrated value of the intake air amounts that an air flow meter 31 has detected, and an estimated value or a detected value (by a thermocouple and so forth) of the catalyst temperature, and in a case where it has reached each predetermined standard value, it is affirmed and this routine is terminated. In a case where catalyst warm-up is not completed, the processes from steps S50 to S90 and S120 are repetitively executed.

As described above, in the first embodiment, in a case where the catalyst warm-up request has been made, the ECU 50 executes the ignition retard angle operation and the A/F vibration operation (S40), and the early closing operation of the exhaust valve 14 (S60), and in a case where combustion is unstable, makes small the ignition retard angle amount of the lean cylinder in the ignition retard angle operation (S80), and enlarges the A/F amplitude (S90) in comparison with a case where the combustion is stable. Accordingly, in the present embodiment, it is possible to compensate for lowering of the warm-up performance of the catalyst in association with ignition advance, by enlargement of the A/F amplitude, while accelerating the stability of combustion by advancement of the ignition timing and suppressing worsening of the drivability.

Incidentally, in a case were the VVT mechanisms 41 and 42 have the function of controlling the valve lift amount, advancement of the opening timing of the exhaust valve 14 can be suppressed by correction of the valve lift amount to the increased side in execution of the early closing operation of the exhaust valve 14. In a case where such increasing of the lift amount has been performed, at least one of the correction amount of the ignition timing to the advance angle side instep S80, and the correction amount of the A/F amplitude to the increased amount, may be suppressed.

### Second Embodiment

Next, the second embodiment of the present invention will be described. When the early closing operation of the exhaust valve 14 and the A/F vibration operation are simultaneously executed as in the above-mentioned first embodiment, there are cases where the combustibility directly after termination of the A/F vibration operation is worsened in the cylinder to which the lean combustion has been allocated in the A/F vibration operation. The main cause thereof lies in that when the state shifts to a light loaded state such as idling after termination of the A/F vibration operation, the throttle valve 6 is closed, the intake pipe negative pressure becomes large in absolute value and the amount (the so-called internal EGR amount) of the burned gas that is sucked again into the combustion chamber becomes large. In addition, when the throttle opening is increased by the above-mentioned throttle opening correction (S100) in order to cancel out the reduction in torque in a case where the A/F amplitude has been increased (S90), the larger the A/F amplitude is, the smaller the intake pipe negative pressure becomes in absolute value and the smaller the internal EGR amount becomes (FIG. 7). Therefore, when the A/F amplitude is large, an increase in internal EGR amount due to a sudden increase in intake pie negative pressure directly after termination of the A/F vibration operation becomes more remarkable and a fear that combustion may be worsened becomes strong.

In order to cope with this problem, in the second embodiment, after termination of the A/F vibration operation, the ignition timing of the cylinder in which the lean combustion has been performed in the A/F vibration operation is corrected to an earlier timing than the ignition timing that has been used in the A/F vibration operation, as the current air-fuel ratio is larger. Since the mechanical configurations of the second embodiment are the same as those in the first embodiment, the same numerals are assigned to them and detailed description thereof is omitted.

In the second embodiment, an ignition timing correction amount map such as that shown in FIG. 8 is prepared in advance and is stored in the ROM of the ECU 50. This map, an air-fuel ratio A/F in the lean cylinder, an internal EGR rate (that is, a volume rate of the burned gas in the gas in the cylinder) in the lean cylinder, and an ignition timing correction amount alean are stored in association with one another. In FIG. 8, the ignition timing correction amount alean is indicated by an advance angle amount, that is, the crank angle with the advance angle side being set positive, and the larger the value thereof is, the more the ignition timing is advanced. In this map, setting is made such that the larger (leaner) the air-fuel ratio A/F in the lean cylinder is and the larger the internal EGR rate in the cylinder is, the larger the ignition timing correction amount alean becomes (is advanced). Although a target air-fuel ratio is used for the air-fuel ratio A/F, a detected or estimated air-fuel ratio may be used.

Control in the second embodiment will be described in the following. In FIG. 9A and FIG. 9B, first, in step S210, the ECU 50 decides whether or not the catalyst rapid warm-up request is present. The decision is made similarly to that in step S10 in the above-mentioned first embodiment.

If YES in step S210, selective execution of the early closing operation, the ignition retard angle operation and the A/F vibration operation is performed (step S220). The process in step S220 is performed similarly to those in steps S20 to S120 in the above-mentioned first embodiment. In a case where it has been determined that the catalyst warm-up has been completed by the process corresponding to that in step S110 in the first embodiment, the process shifts to step S230.

In step S230, the ECU 50 determines whether the predetermined idling condition is satisfied. The idling condition here means that, for example, a state where the operation of an accelerator pedal is not performed and a vehicle speed is zero lasts exceeding a predetermined time. If NO in step S230, that is, if the idling condition is not satisfied, the process is returned.

If YES in step S230, that is, if the idling condition is satisfied, the process shifts to step S240. In step S240, the ECU 50 determines whether correction of the A/F amplitude in the A/F vibration operation to the increased side has been executed in the previous step S220. This correction of the A/F amplitude to the increased side corresponds to that in step S90 in the first embodiment. If NO, that is, if correction of the A/F amplitude to the increased side is not executed, the process is returned.

If YES, that is, if correction of the A/F amplitude to the increased side is executed, next in step S250, the ECU 50 determines whether the correction amount relevant to the correction of the A/F amplitude was larger than a predetermined standard value. If NO, that is, if the correction amount was not more than the standard value, the process is returned.

If YES, that is, if the correction amount is larger than the standard value, next in step S260, the ECU 50 calculates a target air amount. This target air amount is a target value of the intake air amount corresponding to the engine speed and the fuel injection amount in the idling state after completion of the catalyst warm-up.

Next, the ECU 50 calculates the current air-fuel ratio A/F of the lean cylinder (step S270). This calculation can be performed on the basis of the intake air amount EL that the air flow meter 31 has detected and the fuel injection amount of the lean cylinder.

Next, the ECU 50 calculates the ignition timing correction amount alean of the lean cylinder (step S280). This calculation is executed in accordance with the ignition timing correction amount map shown in FIG. 8. The ECU 50 searches the ignition timing correction amount map on the basis of the air-fuel ratio A/F in the lean cylinder and the internal EGR rate in the lean cylinder, and acquires the corresponding ignition timing correction amount alean. The internal EGR rate can be estimated by the predetermined map or function on the basis of, for example, the intake air amount KL corresponding to the requested load, the valve timing, and the intake pipe negative pressure detected by a not shown intake pressure sensor. The larger (that is, leaner) the air-fuel ratio A/F in the lean cylinder is, the larger the ignition timing correction amount alean is made, in accordance with the ignition timing correction amount map in FIG. 8. That is, the ignition timing of the lean cylinder is corrected to the advance angle side, as the amplitude of the A/F vibration operation is larger.

The ignition timing is calculated by addition of the ignition timing correction amount alean to a basic ignition timing abase. The basic ignition timing abase is calculated with the map or function on the basis of the engine speed Ne and the requested load KL by separate basic ignition timing control. The ECU 50 determines whether the ignition timing so calculated is within an allowable range (step S290). An advance angle guard that is a limit on the advance angle side, and retard angle guard that is a limit on the retard angle side, are provided for the ignition timing. The advance angle guard is the ignition timing that is set on the most retard angle side in the ignition timings in which knocking occurs. The retard angle guard is the ignition timing that is set on the most advance angle side in the ignition timings in which all of the energy is not consumed for the torque for driving the engine 8. The advance angle guard and the retard angle guard can be set such that, for example, the requested torque can be obtained, knocking does not occur, or the concentrations of HC and CO in the exhaust air do not exceed threshold values. The advance angle guard and the retard angle guard may not be fixed. The ignition timing is controlled to be set between the advance angle guard and the retard angle guard. That is, if NO in step S290, that is, if the calculated target ignition timing is determined to be out of the allowable range, the ECU 50 changes the ignition timing correction amount such that the ignition timing falls within the allowable range (step S300). If the ignition timing is within the allowable range, step S300 is skipped.

For example, in FIG. 8, it is assumed that A/F in the lean cylinder and the internal EGR rate are present at a point C1 and the ignition timing that is obtained by adding the ignition timing correction amount alean that corresponds to this point C1 to the basic ignition timing abase is present on the more advance angle side than the advance angle guard. In this case, in step S300, the ignition timing correction amount alean is changed and corrected such that the ignition timing is set on the more retard angle side than the advance angle guard. In addition, A/F in the lean cylinder is corrected to the rich side and A/F in the lean cylinder and the internal EGR rate are moved to a point C2. That is, A/F in the lean cylinder is corrected to the rich side in response to correction of the ignition timing to the retard angle side. Correction of this A/F in the lean cylinder to the rich side is performed by increasing the fuel injection amount.

Next, the ECU 50 changes the throttle opening throughout a predetermined unit amount so as to approach the target air amount calculated in step S260 (step S310). In addition, the ECU 50 executes ignition by using the ignition timing obtained by adding the ignition timing correction amount alean that has been calculated in step S280 or changed in step S300 to the basic ignition timing abase (step S320).

Processes in steps S270 to S320 are repetitively executed until the intake air amount converges to a target value (step S330). When the intake air amount converged to the target value, the present routine is terminated.

FIG. 10 is a timing chart showing an operation state of each part when the above catalyst warm-up process is executed. In FIG. 10, first, the engine 8 starts up (i), and in a case where the rapid warm-up request is made, the ignition timing is retarded (ii). When the A/F vibration operation is started (iii), the A/F amplitude is gradually enlarged (S90, iv), and the ignition timing of the lean cylinder is gradually advanced (v) and the ignition timing of the rich cylinder is gradually retarded. Since combustion is worsened with the lean gaseous mixture in the lean cylinder and combustion becomes favorable with the rich gaseous mixture in the rich cylinder, this is done in order to suppress a torque difference between them. For cancellation of a reduction in torque of the lean cylinder caused by an increase in A/F amplitude (S90), the throttle opening of the lean cylinder is gradually increased by the above-mentioned throttle opening correction (S100). Accordingly, the intake pipe pressure is gradually increased (that is, the negative pressure is decreased) (vi).

When warm-up of the catalyst is completed (vii) and the idling condition is satisfied (S230), the A/F vibration operation is terminated and the engine 8 shifts to an idling state. The throttle valve 6 is closed in association with this shifting and the intake pipe negative pressure becomes large in absolute value (viii). In addition, since valve overlapping is started again due to termination of the early closing operation, the internal EGR amount is abruptly increased (ix)

Here, if correction of the A/F amplitude in the A/F vibration operation to the increased side is executed (S240) and the correction amount relevant to the correction was larger than the predetermined standard value (S250), the ignition timing of the lean cylinder is corrected to the advance angle side in steps S280 to S300 (x). When processes in steps S270 to S320 are repetitively executed until the intake air amount converges to the target value (step S330), the advance angle amount of the ignition timing is gradually decreased and it is shifted to a steady state of idling (xi). In parallel with this, the lean cylinder A/F (xii) and the valve timing of the exhaust valve (xiii) are also gradually shifted to steady states of idling.

As thus described, in the second embodiment, after termination of the A/F vibration operation (S230, S240), the larger the current air-furl ratio is, the larger the ECU 50 corrects the ignition timing of the lean cylinder, in which the lean combustion has been performed in the A/F vibration operation, from the ignition timing used in the lean combustion to the advance angle side (S280, FIG. 8). Thereby, worsening of the combustibility directly after termination of the A/F vibration operation in the lean cylinder can be suppressed. Accordingly, worsening of the emission and worsening of the drivability can be suppressed.

The present invention is not limited to the above-mentioned aspects and all modified examples and applied examples, and equivalents included in the concept of the present invention that is defined by the scope of the patent claims are included in the present invention. Accordingly, the present invention should not be limitedly interpreted and is also applicable to optional other technologies that fall within the range of the concept of the present invention.

For example, although determination as to whether the combustion is unstable in step S70 has been made on the basis of the engine speed Ne, it is also possible to instead perform it by other methods such as a method of using a cylinder inner pressure fluctuation that has been detected or estimated.

Although, in the above-mentioned each embodiment, the three-way catalyst 21 has been used as the catalyst, the present invention can be applied to other kinds of catalysts, in particular, various kinds of catalysts requiring a heating process up to the activation temperature. Although in the above-mentioned each embodiment, the present invention has been applied to the gasoline internal combustion engine, it is also possible to apply the present invention to internal combustion engines using fuels other than gasoline such as diesel engines and gaseous fuel engines, and such configurations also fall under the category of the present invention.

### REFERENCE SIGNS LIST

3 intake passage
8 engine
8a cylinder
10 fuel injection valve
12 ignition plug
18 exhaust passage
21 three-way catalyst
50 ECU

1. A control device for an internal combustion engine configured to control an internal combustion engine including a catalyst unit in an exhaust passage, the control device comprising:
A/F vibration unit for causing lean combustion to be performed in at least one cylinder and causing rich combustion to be performed in at least one another cylinder in a case where a warm-up request of said catalyst unit has been made;
early closing unit for advancing a valve closing timing of an exhaust valve to an earlier timing than an intake top dead center in a case where said warm-up request has been made; and
ignition retard angle unit for retarding an ignition timing in a case where said warm-up request has been made, wherein
said control device is further configured, in a case where combustion is unstable, to make small a retard angle amount of an ignition timing of the cylinder in which the lean combustion is performed, the retard angle amount of an ignition timing being provided by said ignition retard angle unit, and to make large an amplitude of an air-fuel ratio that is provided by said A/F vibration unit, in comparison with a case where the combustion is stable.

2. The control device for an internal combustion engine according to claim 1, wherein
said control device is further configured, after termination of operation of said A/F vibration unit, to correct the ignition timing of the cylinder in which the lean combustion has been performed by said A/F vibration unit, to an earlier timing than the ignition timing that has been used in the lean combustion, as a current air-fuel ratio is larger.
